(19) United States
(12) Patent Application Publication
(10) Pub. No.: US 2002/0073806 A1
(43) Pub. Date: Jun. 20, 2002

(54) Stick tack

(76) Inventor: Lary Harmon, Solana Beach, CA (US)

Correspondence Address: LARY HARMON, 524 F Via De La Valle, Solana Beach, CA, 92075, US

(21) Appl. No.: 09/737,021

(22) Filed: Dec. 13, 2000

Related U.S. Application Data
(63) Continuation of application No. 60/170,725, filed on Dec. 15, 1999.

(51) Int. Cl. B25C 3/00

(52) U.S. Cl. 81/44

(57) ABSTRACT

The Stick Tack is a device to house a tack for it's installation or removal to ceilings or out of reach area's, from a ground level.

### BACK ROUND OF INVENTION

1. Field of Invention

This invention relates to devices used to, install and remove tacks, The new device provides a simple means for the user to install and remove tacks into a ceiling or such at a ground level, as one would do for decorating a room for a party.

2. Description of Related Art

The current way of installing and removing tacks to a ceiling or such, is by the use of a ladder and ones hand. Having to install or remove tacks from high places can become difficult if not dangerous when a ladder is needed. The present invention provides user to install and remove tacks from ground level.

### SUMMARY OF THE INVENTION

The objective of the presented invention is to enable the user to install and remove tacks from ground level. In accordance with the description presented herein, other objectives of this invention will become apparent when the description and drawings are reviewed.

### BRIEF DESCRIPTION OF DRAWINGS

FIG. 1 Illustrates perspective side and top view of Cap with a Key Hole cut out.

FIG. 2 Illustrates side and top view of Dowel (Handle), with drilled hole.

FIG. 3 Illustrates side view of, Cap and Dowel assembly.

FIG. 4 Illustrates side and top view with tack in place for installing.

FIG. 5 Illustrates side and top view with tack in position for removal.

FIG. 6 Illustrates side view of motion used to remove or install tack.

FIG. 7 Illustrates a side and top view of type tack to be used with presented invention.

### DESCRIPTION OF THE PREFERRED EMBODIMENT

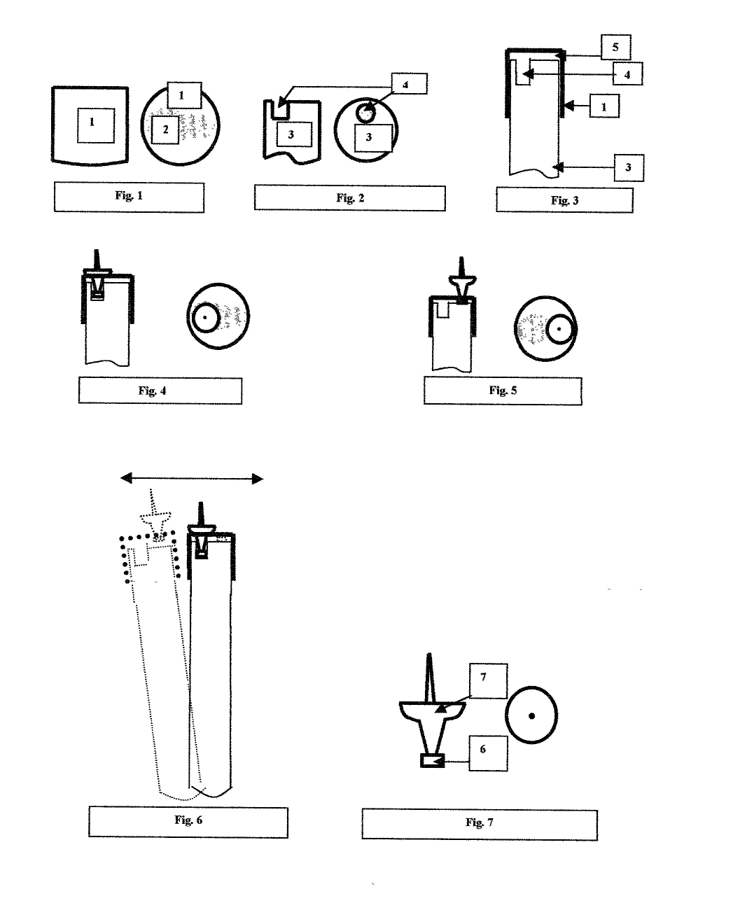

The Stick Tack consists of a stick, handle, or pole,(FIG. 2.3) with a Cap (FIG. 1) attached to its top, in the top of Cap is a cut out with a shape of a Key Hole(FIG. 1.2), with this Key Hole shape it allows a tack to be captured by its base or head.(FIG. 7.7 being the base and FIG. 7.6 being the head).

FIG. 3 shows the Stick Tack assembly

FIG. 2.4 is hole tack head (FIG. 7.6) will rest in during the installation of tack.(See FIG. 4 tack in position for installation).

FIG. 3.5 is air gap that is necessary for removal of tack.(See FIG. 5 tack in position for removal).

FIG. 6 over all drawing.

1. A device for installing and removing tacks.

2. The device as in claim one, enables user to install and remove tacks from a ground level.

3. The device as in claim one has a Key Hole cut out in cap which enables user to position tack for installation or position cap for tack removal.

4. As in claim one the Cap is attached to a long gated dowel of wood, plastic or metal. The Stick Tack is a device to house a tack for it's installation or removal to ceilings or out of reach area's from a ground level.
